(19) United States
(12) Patent Application Publication
(10) Pub. No.: US 2019/0344621 A1
(43) Pub. Date: Nov. 14, 2019

(54) Non-Pneumatic Tire

(71) Applicants: Ryan GAYLO, Simpsonville, SC (US); Brian NAROWSKI, Greenville, SC (US); Timothy Brett RHYNE, Simpsonville, SC (US); Steven M. CRON, Greenville, SC (US)

(72) Inventors: Ryan GAYLO, Simpsonville, SC (US); Brian NAROWSKI, Greenville, SC (US); Timothy Brett RHYNE, Simpsonville, SC (US); Steven M. CRON, Greenville, SC (US)

(73) Assignee: Compagnie Générale des Établissements Michelin, Clermont-Ferrand (FR)

(21) Appl. No.: 16/474,411

(22) PCT Filed: Dec. 27, 2017
(86) PCT No.: PCT/US2017/068499

§ 371 Date: Jun. 27, 2019

(30) Foreign Application Priority Data
Dec. 30, 2016 (US) PCT/US2016/069388

(51) Int. Cl. B60C 7/18; B60C 11/00; B60C 11/03

(52) U.S. Cl. CPC B60C 7/18; B60C 11/005; B60C 2007/107; B60C 11/0306; B60C 11/0302

(57) ABSTRACT

A non-pneumatic tire (10) including a rigid central annular portion (12), an annular shear band (14), one or more deformable spokes (16), a tread (18), a plurality of tread elements, one or more displaced reinforcement layers arranged within the annular shear band (14) such that a longitudinal groove extends through at least one of the one or more displaced reinforcement layers wherein the one or more displaced reinforcement layers are arranged between one or more non-displaced reinforcement layers and the tread (18).

### CROSS-REFERENCE TO RELATED APPLICATIONS

This application claims priority to, and the benefit of, International Patent Application No. PCT/US2016/069388, filed Dec. 30, 2016 with the U.S. Patent Office (acting as the US Receiving Office), which is herein incorporated by reference.

### BACKGROUND

### Field

The embodiments herein relate generally to shear bands and treads for use with non-pneumatic tires.

### Description of the Related Art

It is appreciated that a reduction in the rolling resistance of a tire may improve fuel efficiency by reducing the amount of energy wasted during use. However, in an effort to reduce the rolling resistance of a tire, other sacrifices are often made, which may result in the reduction of other performance measures. For example, when reducing the rolling resistance of a tire, the tread thickness is often reduced, along with the voids contained therein. As a result, wet weather performance is negatively impacted due to the reduction in void volume. In instances such as this, there is a desire to reduce the tread thickness to reduce rolling resistance while maintaining a desired groove depth to help maintain a desired level of wet weather performance. Specifically, when reducing the tread thickness, the depth of any longitudinal groove is also reduced, which immediately reduces void volume useful for consuming water to promote tread-road contact. If the grooves are widened to recapture lost void, a reduction is contact surface area decreases, which reduces the amount of traction available and, in turn, reduces certain tire performance measures. Accordingly, there is a need for an improved tire tread capable of reducing rolling resistance while also minimizing any reduction in wet weather performance.

### SUMMARY

Particular embodiments herein comprise a non-pneumatic tire. The non-pneumatic tire comprises a rigid central annular portion, an annular shear band circumferentially arranged about the central annular portion, and one or more deformable spokes arranged between the annular shear band and the central annular portion. The non-pneumatic tire further includes a tread defining an outer, ground-engaging side of the non-pneumatic tire extending annularly around the non-pneumatic tire. The tread has a length, a thickness extending radially inward from the ground-engaging side to a bottom side of the tread, and a width extending laterally between a pair of opposing lateral sides of the tread. The width of the tread also extends transverse to a direction of the tread thickness and to a direction of the tread length. The non-pneumatic tire further includes a plurality of tread elements arranged along the outer, ground-engaging side of the tread. The plurality of tread elements include at least one pair of tread elements spaced apart by a longitudinal groove, which extends primarily in the direction of the tread length. The non-pneumatic tire further includes one or more displaced reinforcement layers extending circumferentially around the non-pneumatic tire and in a direction of the tread width. The one or more displaced reinforcement layers are arranged within the annular shear band such that the longitudinal groove extends through at least one of the one or more displaced reinforcement layers and, therefore, separates opposing portions of the at least one of the one or more displaced reinforcement layers. The non-pneumatic tire further includes one or more non-displaced reinforcement layers extending circumferentially around the non-pneumatic tire and in the direction of the tread width. The one or more non-displaced reinforcement layers are arranged within the annular shear band. The one or more displaced reinforcement layers are arranged between the tread and the one or more non-displaced reinforcement layers.

The foregoing and other embodiments, objects, features, and advantages of the embodiments herein will be apparent from the following more detailed descriptions of particular embodiments, as illustrated in the accompanying drawings wherein like reference numbers represent like parts of the embodiments.

### BRIEF DESCRIPTION OF THE DRAWINGS

FIG. 1 is a perspective view of a non-pneumatic tire, in accordance with an embodiment.

FIG. 2 is a sectional view of a prior art non-pneumatic tire tread taken along line 2-2 of the tire shown in FIG. 1.

FIG. 3 is a sectional view of an improved non-pneumatic tire tread, the improved non-pneumatic tire tread being an improvement of the prior art non-pneumatic tire tread shown in FIG. 2, in accordance with an embodiment.

### DETAILED DESCRIPTION

Embodiments herein describe an improved non-pneumatic tire.

In particular embodiments, a non-pneumatic tire comprises a rigid central annular portion. The non-pneumatic tire further comprises an annular shear band, which is circumferentially arranged about the central annular portion. The annular shear band includes a plurality of reinforcement layers, each such layer including a plurality of elongate reinforcements. Neither the shear band nor the non-pneumatic tire is configured to retain any pressurized air. The non-pneumatic tire further comprises one or more deformable spokes, which are arranged between the annular shear band and the central annular portion. The one or more deformable spokes are spaced apart around a rotational axis of the central annular portion or more generally of the non-pneumatic tire, where a length of the each deformable spoke extends primarily in a radial direction of the central annular portion or non-pneumatic tire. The rotational axis of the central annular portion and the non-pneumatic tire corresponds to an axial direction of the central annular portion and the non-pneumatic tire. The axial direction of the central annular portion or non-pneumatic tire is perpendicular to the radial direction thereof. The annular shear band is operably attached to a radially outward extent of the one or more deformable spokes, which, are in turn, connected at a radially inward extent to the central annular portion.

The non-pneumatic tire further includes a tread. The tread defines an outer, ground-engaging side of the non-pneumatic tire, which extends annularly around the non-pneumatic tire and the shear band. The tread has a length, which extends in a circumferential direction of the non-pneumatic tire. The tread also has a thickness, which extends radially inward from the ground-engaging side of the tread to a bottom side of the tread. The tread thickness extends perpendicular to the tread length. The tread further includes a width, which extends laterally between a pair of opposing lateral sides of the tread. The width of the tread extends perpendicular, or transverse, to both a direction of the tread thickness and a direction of the tread length.

In particular embodiments, the non-pneumatic tire further includes a plurality of tread elements. Tread elements are generally formed by spaced apart voids or a lateral side of the tread spaced apart from any one or more voids. The plurality of tread elements are arranged along the outer, ground-engaging side of the tread and are spaced apart by a longitudinal groove. A longitudinal groove extends primarily in the direction of the tread length (i.e., the circumference of the non-pneumatic tire when utilized therewith), although it is not required to extend the full length of the tread. It is appreciated that the tread may include more than one longitudinal groove.

To permit a reduction of tread thickness without sacrificing longitudinal groove depth, one or more of the shear band reinforcement layers is parsed or separated, such that a portion of the reinforcement layer is eliminated (“displaced”) to create a spacing or void within the layer through which a longitudinal groove extends. By doing so, the depth of the longitudinal groove is equal to or greater than a maximum thickness of the tire tread as measured along a tread element arranged adjacent (next to) the longitudinal groove. The portion of the tread thickness associated with the tread element is measured from the most radially outward point (outermost radial point) of the annular shear band below the tread element to the outer, ground-engaging side of the tread associated with the corresponding tread element. In certain embodiments, the depth of the longitudinal groove is equal to at least one hundred twenty-five percent (125%) of the adjacent tread element thickness. In other embodiments, the depth of the longitudinal groove is equal to at least two hundred percent (200%) of the adjacent tread element thickness. In these embodiments, for example, the depth of the longitudinal groove may be equal to twelve millimeters, and the maximum thickness of the adjacent tread element may be equal to six millimeters. It is appreciated that, if the tread includes more than one longitudinal groove, the depth of each longitudinal groove may not be equal to the depth of all other longitudinal grooves or, in alternate embodiments, the depth of each longitudinal groove may not be equal to the depth of any of the other longitudinal grooves.

It is appreciated that any tread element may form a rib or a tread block (“lug”). A rib may extend continuously along the tread length, or may include intervening sipes or lateral grooves to form a discontinuous rib. A block is a tread element bounded by spaced apart lateral grooves or sipes. A tread block may be arranged with other blocks to form a discontinuous rib. For example, in certain embodiments, the plurality of tread elements of the non-pneumatic tire include at least one pair of tread elements spaced apart by a lateral groove. The lateral groove extends primarily in the direction of the tread width (i.e., the axial direction of the non-pneumatic tire when utilized therewith), although it is not required to extend fully across the width of the tread. It is appreciated that the tread may include more than one lateral groove.

As previously noted, the non-pneumatic tire includes a plurality of reinforcement layers arranged within the annular shear band. At least one, or a plurality, of the plurality of reinforcement layers includes one or more displaced (i.e., discontinuous) reinforcement layers extending circumferentially around the non-pneumatic tire and in a direction of the tread width. Each of the one or more displaced reinforcement layers includes a discontinuity (also referred to as a “spacing” or “void”) into which a longitudinal groove extends as noted previously. When multiple displaced reinforcement layers are present, the multiple displaced reinforcement layers are stacked together to create a common discontinuity where the discontinuity of each layer is laterally aligned (or “stacked”) such that the discontinuities together form the common discontinuity. In the end, the one or more displaced reinforcement layers are arranged within the annular shear band such that a longitudinal groove extends through the one or more displaced reinforcement layers. In these embodiments, the longitudinal groove separates opposing portions of the one or more displaced reinforcement layers located below opposing tread elements arranged on either side of the longitudinal groove in the direction of the tread width. The plurality of reinforcement layers also includes one or more non-displaced (i.e., continuous) reinforcement layers extending circumferentially around the non-pneumatic tire and across the tread width and in the direction of the tread width. The one or more non-displaced reinforcement layers are arranged within the annular shear band such that the longitudinal groove does not extend through any of the one or more non-displaced reinforcement layers. The one or more displaced reinforcement layers are arranged between the tread and the one or more non-displaced reinforcement layers.

In particular embodiments, the one or more displaced reinforcement layers and the one or more non-displaced reinforcement layers extend linearly or along a slightly arcuate path in the direction of the tread width. In other words, none of the plurality of reinforcement layers forming the common discontinuity in the shear band extend laterally, that is, in the direction of the tread width, along any alternating non-linear path to form the common discontinuity into which a longitudinal groove extends.

In particular embodiments, due to the structure of the annular shear band in relation to the one or more longitudinal grooves, the one or more longitudinal grooves are able to utilize the entire tread depth, which results in the longitudinal grooves remaining active throughout an entire useful life of the tread. With respect to the stacked arrangement of the plurality of reinforcement layers, the size and depth of the reinforcement stacks are a function of the desired width of the tread element and the required depth of the one or more longitudinal grooves. In this way, a more shallow tread depth may be employed with the one or more longitudinal grooves having an increased depth due to the stacked arrangement of the plurality of reinforcement layers. As a result, the rolling resistance and mass of the non-pneumatic tire is reduced without sacrificing wet weather performance.

Particular embodiments of the non-pneumatic tires discussed above will now be described in further detail below in association with the figures filed herewith exemplifying the embodiments.

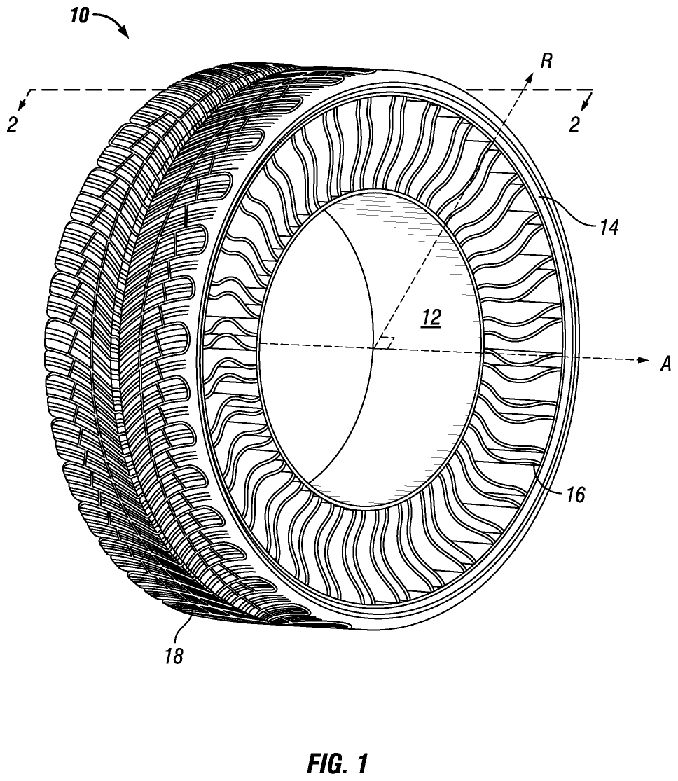

With reference to an exemplary embodiment shown in FIG. 1, a non-pneumatic tire 10 is illustrated. The non-pneumatic tire 10 comprises a rigid central annular portion 12. The non-pneumatic tire 10 further comprises an annular shear band 14, which is circumferentially arranged about the central annular portion 12 but not directly contacting the central annular portion 12. The non-pneumatic tire 10 further comprises a plurality of deformable spokes 16, which are arranged between the annular shear band 14 and the central annular portion 12. The plurality of deformable spokes 16 are spaced apart around a rotational axis of the central annular portion 12, which is also a rotational axis of the non-pneumatic tire 10. The rotational axis of the central annular portion 12 and of the non-pneumatic tire 10 corresponds to an axial direction A of the central annular portion 12 and of the non-pneumatic tire 10. In this way, a length of each of the deformable spokes 16 extends in a radial direction R of the central annular portion 12 of the non-pneumatic tire 10. The axial direction A of the central annular portion 12 and of the non-pneumatic tire 10 is perpendicular to the radial direction R thereof. The annular shear band 14 is operably attached to a radially outward extent of the plurality of deformable spokes 16, which, are in turn, connected at a radially inward extent to the central annular portion 12.

The non-pneumatic tire 10 of FIG. 1 also includes a tread 18. With specific reference to FIG. 2, a prior art non-pneumatic tire tread is illustrated. The non-pneumatic tire tread includes an annular shear band 114 configured to extend circumferentially around a central annular portion of a non-pneumatic tire (not shown). The tread 118 includes an outer, ground-engaging side 120 and a bottom side 122. The tread 118 has a length configured to extend circumferentially around the tire and a thickness T₁₁₈ extending radially inward from the ground-engaging side 120 to the bottom side 122 of the tread 118, the length being perpendicular to the thickness. The tread 118 further includes a width W₁₁₈, extending laterally between a pair of opposing lateral sides of the tread 118. The width W₁₁₈ extends perpendicular to the tread thickness T₁₁₈ and to the tread length.

The prior art tread 118 includes a plurality of tread elements 124 arranged along the outer, ground-engaging side 120 of the tread 118. The portion of the tread thickness T₁₁₈ arranged within a tread element 124 has a thickness T₁₂₄, which extends radially outward from a most radially outward point of the annular shear band 114 below the tread element 124 to the outer, ground-engaging side 120 of the tread 118. In the exemplary prior art non-pneumatic tire tread shown, a pair of tread elements 124 are spaced apart by a longitudinal groove 126. Each longitudinal groove 126 has a depth D₁₂₆, which extends from the outer, ground-engaging side 120 of the corresponding tread element 124 to a bottom of the longitudinal groove 126. Of final note, the annular shear band 114 includes a plurality of reinforcement layers 128, each such layer 128 including a plurality of elongate reinforcements 130.

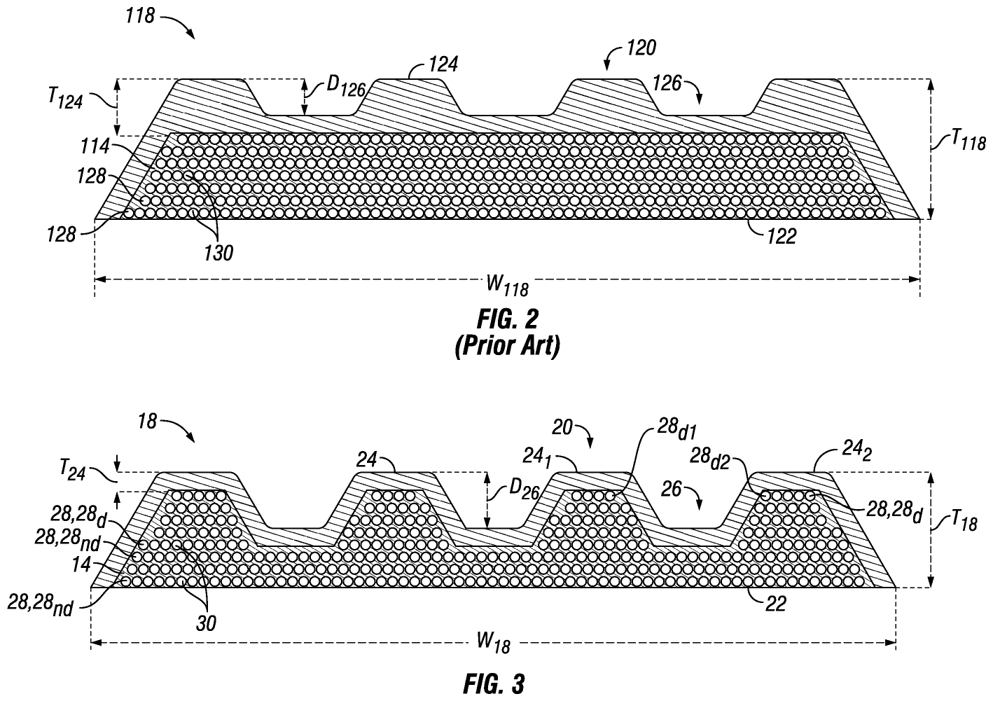

With reference to FIG. 3, an improved non-pneumatic tire tread 18 is illustrated. The tread 18 defines an outer, ground-engaging side 20 of the non-pneumatic tire 10. The outer, ground-engaging side 20 of the tread 18 extends annularly around the non-pneumatic tire 10 and the annular shear band 14. The tread 18 also has a length, which extends in a circumferential direction of the non-pneumatic tire 10. The tread 18 has a thickness T₁₈, which extends radially inward from the outer, ground-engaging side 20 of the tread 18 to a bottom side 22 of the tread 18. The tread thickness T₁₈ extends perpendicular to the tread length. The tread 18 further includes a width W₁₈, which extends laterally between a pair of opposing lateral sides of the tread 18. The width W₁₈ extends perpendicular, or transverse, to both a direction of the tread thickness T₁₈ and a direction of the tread length.

As further illustrated in FIG. 3, the tread 18 of the non-pneumatic tire 10 further includes a plurality of tread elements 24. The plurality of tread elements 24 are arranged along the outer, ground-engaging side 20 of the tread 18 and are spaced apart from each other by longitudinal grooves 26. Each longitudinal groove 26 extends primarily in the direction of the length of the tread 18, which corresponds to the circumference of the non-pneumatic tire 10 when the tread 18 is utilized therewith. Further, each longitudinal groove 26 has a depth D₂₆, which extends primarily in the direction of the tread thickness T₁₈. The depth D₂₆ of the longitudinal groove 26 greater than a maximum thickness T₂₄ as measured along a tread element 24 arranged adjacent to the longitudinal groove 26. The thickness T₂₄ of a tread element 24 is measured from the most radially outward point of the annular shear band 14 below the tread element 24 to the outer, ground-engaging side 20 of the tread 18 associated with the corresponding tread element 24.

As further shown in FIG. 3, the annular shear band 14 of the non-pneumatic tire 10 includes a plurality of reinforcement layers 28 arranged within the annular shear band 14, each such layer 28 including a plurality of elongate reinforcements 30. The plurality of reinforcement layers 28 include both displaced (i.e., discontinuous) reinforcement layers 28_{d} and non-displaced (i.e., continuous) reinforcement layers 28_{nd}. Each reinforcement layer 28, including each non-displaced reinforcement layer 28_{nd} and each displaced reinforcement layer 28_{d}, extend circumferentially around the non-pneumatic tire 10 and in a direction of the tread width W₁₈. The displaced reinforcement layers 28_{d} are arranged within the annular shear band 14 such that at least one of the longitudinal grooves 26 extends through at least one of the displaced reinforcement layers 28_{d}. In this embodiment, the longitudinal groove 26 separates opposing portions 28_{d1} and 28_{d2} of each of the displaced reinforcement layers 28_{d}. The opposing portions 28_{d1} and 28_{d2} of each of the displaced reinforcement layers 28_{d} are located below opposing tread elements 24₁ and 24₂ arranged on either side of the corresponding longitudinal groove 26 in a direction of the tread width W₁₈. In addition, a plurality of non-displaced reinforcement layers 28_{nd} are arranged within the annular shear band 14 of the non-pneumatic tire 10 such that the corresponding longitudinal grooves 26 do not extend through any of the plurality of non-displaced reinforcement layers 28_{nd}. The plurality of displaced reinforcement layers 28_{d} are arranged between the tread 18 and the plurality of non-displaced reinforcement layers 28_{nd}. The plurality of displaced reinforcement layers 28_{d} and the plurality of non-displaced reinforcement layers 28_{nd} extend linearly in the direction of the tread width W₁₈.

In the embodiment of FIG. 3, the plurality of displaced reinforcement layers 28_{d} are arranged within the annular shear band 14 in a stacked arrangement in the direction of the tread thickness T₁₈. In this way, the longitudinal grooves 26 extend to a depth within the annular shear band 14 that is more radially inward than a thickness T₂₄ of an adjacent tread element 24.

To the extent used, the terms “comprising,” “including,” and “having,” or any variation thereof, as used in the claims and/or specification herein, shall be considered as indicating an open group that may include other elements not specified. The terms “a,” “an,” and the singular forms of words shall be taken to include the plural form of the same words, such that the terms mean that one or more of something is provided. The terms “at least one” and “one or more” are used interchangeably. The term “single” shall be used to indicate that one and only one of something is intended. Similarly, other specific integer values, such as “two,” are used when a specific number of things is intended. The terms “preferably,” “preferred,” “prefer,” “optionally,” “may,” and similar terms are used to indicate that an item, condition or step being referred to is an optional (i.e., not required) feature of the embodiments. Ranges that are described as being “between a and b” are inclusive of the values for “a” and “b” unless otherwise specified.

While the embodiments have been described with reference to particular embodiments thereof, it shall be understood that such description is by way of illustration only and should not be construed as limiting the scope of the claims herein. Accordingly, the scope and content herein are to be defined only by the terms of the following claims. Furthermore, it is understood that the features of any specific embodiment discussed herein may be combined with one or more features of any one or more embodiments otherwise discussed or contemplated herein unless otherwise stated.

1. A non-pneumatic tire comprising:
a rigid central annular portion;
an annular shear band circumferentially arranged about the rigid central annular portion;
one or more deformable spokes arranged between the annular shear band and the rigid central annular portion;
a tread defining an outer, ground-engaging side of the non-pneumatic tire extending annularly around the non-pneumatic tire, wherein the tread has a length, a thickness extending radially inward from the outer, ground-engaging side to a bottom side of the tread, and a width extending laterally between a pair of opposing lateral sides of the tread, the width extending transverse to a direction of the tread thickness and to a direction of the tread length;
a plurality of tread elements arranged along the outer, ground-engaging side of the tread, where the plurality of tread elements include at least one pair of tread elements spaced apart by a longitudinal groove, the longitudinal groove extending primarily in the direction of the tread length;
one or more displaced reinforcement layers extending circumferentially around the non-pneumatic tire and in a direction of the tread width, the one or more displaced reinforcement layers being arranged within the annular shear band where the longitudinal groove extends through at least one of the one or more displaced reinforcement layers and thereby separates opposing portions of the at least one of the one or more displaced reinforcement layers; and
one or more non-displaced reinforcement layers extending circumferentially around the non-pneumatic tire and in the direction of the tread width, the one or more non-displaced reinforcement layers being arranged within the annular shear band, wherein the one or more displaced reinforcement layers are arranged between the tread and the one or more non-displaced reinforcement layers.

2. The non-pneumatic tire of claim 1, wherein the longitudinal groove has a depth extending primarily in the direction of the tread thickness, further wherein the depth of the longitudinal groove is greater than a maximum thickness of an adjacent tread element of the plurality of tread elements, the maximum thickness of the adjacent tread element being measured from an outermost radial point of the annular shear band below the tread element to the outer, ground-engaging side of the tread associated with the adjacent tread element.

3. The non-pneumatic tire of claim 2, wherein the depth of the longitudinal groove is equal to at least 125% of the maximum thickness of the adjacent tread element of the plurality of tread elements.

4. The non-pneumatic tire of claim 1, wherein the one or more displaced reinforcement layers comprises a plurality of displaced reinforcement layers in a stacked arrangement in the direction of the tread thickness.

5. The non-pneumatic tire of claim 1, wherein the one or more displaced reinforcement layers and the one or more non-displaced reinforcement layers extend linearly or along an arcuate path in the direction of the tread width.

6. The non-pneumatic tire of claim 4, wherein more than one additional displaced reinforcement layer forms the stacked arrangement.

7. The non-pneumatic tire of claim 1, wherein each of an additional reinforcement layer of the one or more non-displaced reinforcement layers is continuous.

8. The non-pneumatic tire of claim 1, wherein the plurality of tread elements include at least one pair of tread elements spaced apart by a lateral groove, the lateral groove extending primarily in the direction of the tread width.
